(19) United States
(12) Patent Application Publication
(10) Pub. No.: US 2021/0333160 A1
(43) Pub. Date: Oct. 28, 2021

(54) VISUAL INDICATORS OF BIOSPECIMEN TIME-TEMPERATURE EXPOSURE

(71) Applicants: Chad Borges, Avondale, AZ (US); Kazi Waheeda, Tempe, AZ (US)

(72) Inventors: Chad Borges, Avondale, AZ (US); Kazi Waheeda, Tempe, AZ (US)

(73) Assignee: ARIZONA BOARD OF REGENTS ON BEHALF OF ARIZONA STATE UNIVERSITY, Scottsdale, AZ (US)

(21) Appl. No.: 17/241,917

(22) Filed: Apr. 27, 2021

Related U.S. Application Data
(60) Provisional application No. 63/015,980, filed on Apr. 27, 2020.

(51) Int. Cl. G01K 11/14; A01N 1/02; G01N 31/22

(52) U.S. Cl. CPC G01K 11/14; G01N 31/229; A01N 1/0263

(57) ABSTRACT

An indicator system comprising permanganate, an organic reducing agent, an acid, and optionally an inorganic salt is provided herein, as well as methods for using the indicator system for monitoring the integrity of a biospecimen are provided herein.

### CROSS-REFERENCE TO RELATED APPLICATIONS

This application claims benefit of priority to U.S. application Ser. No. 63/015,980, filed Apr. 27, 2020, the contents of which is incorporated by reference in its entirety.

### BACKGROUND

Many biological analytes of interest to clinical researchers are unstable when the biospecimens in which they reside are thawed, improperly stored, or improperly handled. For example, American Society of Clinical Oncology (ASCO)/College of American Pathologists (CAP) guidelines state that cold ischemic time prior to fixation for tissues collected for clinical HER2 testing in breast cancer must be less than 1 hour. Estrogen receptor (ER) tests are more likely to yield false negative results when tissues are subjected to sustained periods of cold ischemia. Free prostate specific antigen (PSA) in serum loses stability in <4 hrs at 4° C. Cell free DNA is unstable in plasma stored at 4° C. for 24 hrs. And TIMP-1, VEGF and VEGF-R in serum lose stability after about 3 months of storage at −20° C. but are stable at −75° C. Every year, improprieties and inconsistencies in pre-analytical sample handling and storage generate unacceptably large numbers of costly false leads in biomedical research and compromise diagnostic integrity.

Ex vivo biospecimen handling and storage conditions have the potential to impact measurements of certain clinical biomarkers as much or more than in vivo (clinical) conditions of interest. As such, utilization of compromised biospecimens in diagnosis or biomedical research can lead directly to false conclusions. The danger of false discovery/false conclusions is particularly strong for untargeted biomarker discovery studies or in cases of targeted analysis where the stability of the target analyte(s) have not yet been validated. There are numerous pre-analytical variables (PAVs) that can compromise the integrity of tissues and biofluids collected for biomedical research. For frozen specimens the most difficult PAV to control and track over the lifetime of the archived samples is exposure to thawed conditions—particularly at the individual aliquot level. Analytes of clinical interest within all types of frozen biospecimens exhibit quantitative instability when the biospecimen is exposed to thawed conditions. Although this problem is sometimes ignored or given low priority.

The most common ways of dealing with this problem are to follow a standard operating procedure (SOP) and document deviations, or implement evidence-based tracking of biospecimen exposure to thawed conditions. Unfortunately, there are very few tools and no widely accepted approach for evidenced-based biospecimen quality assurance (QA) or quality control (QC) which, in addition to careful SOP adherence and documentation, is undoubtedly the most ideal. In practice, it is actually quite rare for biomedical researchers to employ any evidence-based QA/QC tools at all. Thus there is a need for visual indicators of biospecimen time-temperature exposure.

### SUMMARY OF THE INVENTION

In a first aspect, provided herein is an indicator system comprising permanganate, an organic reducing agent, such as oxalate, an acid, an aqueous solvent, and optionally an inorganic salt initially configured to prevent reduction of the permanganate to Mn²⁺ and a mixture of the permanganate, the organic reducing agent, the acid, the aqueous solvent, and, if present, the inorganic salt is an eutectic composition having a predetermined freezing point. Above the predetermined freezing point the composition is a liquid and the organic reducing agent causes a reduction reaction of pink/purple-colored permanganate to colorless Mn²⁺ or brown MnO₂ and below the predetermined freezing point the composition is a solid and the reduction reaction is stopped. In some embodiments, the eutectic compositions has an initial absorbance at 525 nm greater than 1.00 and is pink in color. In some embodiments, when measured at 525 nm, absorbance of the liquid composition decreases over a predetermined period of time. In some embodiments, when measured at 525 nm, absorbance of the solid composition remains unchanged.

In some embodiments, the eutectic composition additionally comprises an inorganic salt. In some embodiments, the inorganic salt is selected from the group consisting of lithium chloride (LiCl), magnesium chloride (MgCl₂), sodium chloride (NaCl), lithium sulfate (Li₂SO₄), ammonium chloride (NH₄Cl), potassium chloride (KCl), rubidium chloride (RbCl), cesium chloride (CsCl), beryllium chloride (BeCl₂), strontium chloride (SrCl₂), barium chloride (BaCl₂), sodium sulfate (Na₂SO₄), ammonium sulfate ((NH₄)₂SO₄), potassium sulfate (K₂SO₄), rubidium sulfate (Rb₂SO₄), cesium sulfate (Cs₂SO₄), beryllium sulfate (BeSO₄), magnesium sulfate (MgSO₄), strontium sulfate (SrSO₄), and barium sulfate (BaSO₄). In some embodiments, the eutectic composition comprises between about 15% and about 30% by weight of the inorganic salt.

In some embodiments, the predetermined freezing point is selected from the group consisting of 0° C., −33.5° C., and −76° C.

In some embodiments, the indicator system further comprises a multi-chambered storage vessel comprising a removable barrier defining a first chamber having the permanganate therein and a second chamber having the organic reducing agent therein where the removable barrier is configured to prevent the permanganate and the organic reducing agent from mixing. In some embodiments, the first chamber has a solid permanganate salt therein and the second chamber has a solution comprising the organic reducing agent, the acid, the aqueous solvent, and, if present, the inorganic salt therein.

In some embodiments, the indicator system additionally comprises a storage vessel and the eutectic composition is built into a portion of the storage vessel. In some embodiments, the storage vessel is a multi-chambered storage vessel.

In some embodiments, the predetermined freezing point is −33.5° C. and the eutectic composition comprises between 20% and 23% by weight MgCl₂. In some embodiments, the predetermined freezing point is −76° C. and the eutectic composition comprises between 23% and 27% LiCl.

In some embodiments, the eutectic composition comprises between 0.5 and 5 mM potassium permanganate. In some embodiments, the eutectic composition comprise between 0.5 and 5 mM organic reducing agent. In some embodiments, the eutectic composition comprises between 1 mM and 300 mM sulfuric acid.

In a second aspect, provided herein is a biospecimen collection and storage system comprising a storage vessel configured to hold a biospecimen and any of the indicator systems described herein.

In a third aspect, provided herein is a method for monitoring storage of a biospecimen comprising storing a biospecimen in a vessel configured to hold the biospecimen therein; associating any of the indicator systems described herein with the biospecimen or the chamber configured to contain the biospecimen; mixing the permanganate, the organic reducing agent, the acid, the aqueous solvent, and optionally the inorganic salt, thereby forming the eutectic composition; and observing color of the eutectic composition or measuring absorbance at 525 nm; wherein a color change from pink to colorless or absorbance less than 0.1 indicates thawing, improper storage, or improper handling of the biospecimen. In some embodiments, the predetermined freezing temperature is within 5.0° C. of the freezing point of the biospecimen or a storage temperature for the biospecimen.

### BRIEF DESCRIPTION OF DRAWINGS

FIG. 1 shows individual reactions, their rate or equilibrium constants, and rate equations associated with each distinct chemical reaction within the permanganate/oxalic acid/sulfuric acid reaction system.

FIGS. 2A-2B illustrate an exemplary biospecimen collection or storage system having an indicator system (FIG. 2A) and a vessel for holding a biospecimen (FIG. 2B).

FIGS. 3A-3D show permanganate reduction time courses at 25° C. monitored by absorbance at 525 nm, error bars (n=4) represent standard deviation.

FIGS. 3E-3L show photographs of indicator systems at 0 or 4° C. (FIGS. 3E-3H), −20° C. (FIGS. 3I, 3K) and −80° C. (FIGS. 3J, 3L) storage.

### INCORPORATION BY REFERENCE

All publications, patents, and patent applications mentioned in this specification are herein incorporated by reference to the same extent as if each individual publication, patent, and patent application was specifically and individually indicated to be incorporated by reference.

### DETAILED DESCRIPTION OF THE INVENTION

The present disclosure describes colorimetric indicators for monitoring the handling and storage of biospecimens. The change in color of the indicator provides indicates that a biospecimen has thawed, been improperly stored, or improperly handled. The indicator systems described herein serve as a “clock” that slows when samples are cooled and stops when frozen but restarts when thawed. The indicator is not limited to a particular number of freeze/thaw cycles, but rather is a measure of time above a predetermined freezing point threshold temperature.

The presently disclosed indicators provide objective evidence that a biospecimen has been thawed, improperly stored, or improperly handled. Evidence-based biospecimen QA/QC tracking can be broken down into two major forms: endogenous markers and exogenous indicators. Endogenous markers have the advantage that they need not be added to samples at collection, making it possible to use them retrospectively for analysis of existing samples. However, endogenous markers suffer from several inherent disadvantages: they may only be useful for specific biospecimen, testing requires consuming some of the sample, possess natural sample-to-sample variability, require instrumental analysis, and their use may be limited to specific time or temperature regimes.

The presently disclosed exogenous indicators disclosed possess a number of advantages: (1) the indicators work with any type of biospecimen; (2) the indicators eliminate sample consumption or disturbance of the biospecimen as part of the integrity check process; (3) the indicators force itself upon sample handlers with its bright pink indicator, allowing for ultra-rapid visual inspection making it impossible to ignore improperly handled sample; (4) the indicators may be based on inexpensive chemicals, limiting implementation costs; (5) the indicators indicate biospecimen exposure beyond a tightly pre-defined time interval above a given temperature; and (6) the indicators eliminate reliance on written handling/storage records, which may be a common source of false confidence when it comes to the integrity of archived biospecimens.

As used herein, “biospecimen” refers to a sample of material from a human, plant, animal, bacteria, fungi, or other living organism. A biospecimen may be a biofluid (e.g., blood, urine, semen, tears, plasma, sweat, bile, breast milk, cerebrospinal fluid, etc.), a tissue sample (e.g., a biopsy sample, muscle tissue, bone, bone marrow, etc.), cells (e.g., bacterial cells, fungal cell, stem cells, blood cells, bone marrow cells, etc.), or biochemical material (e.g., DNA, RNA, proteins, lysates, etc.).

As used herein, an indication that a biospecimen has been “thawed, improperly stored, or improperly handled” generally means that the biospecimen has been exposed to an undesirably high temperature or an undesirable amount of time that is outside of suitable safe storage and handling parameters for the associated biospecimen. Suitably, safe storage and handling parameters facilitate the stability of the molecular components thereof. When the biospecimen has been thawed, improperly stored, or improperly handled, the biospecimen may have compromised integrity. As used herein, “compromised integrity” means that the biospecimen may lose or develop a quality or characteristic that renders it unsuitable for a diagnostic or analytic use. The biospecimen may be unsuitable for a diagnostic or analytic use because its molecular composition no longer reflects its original state.

The biospecimen is stored adjacent to or in the proximity of the indicator system described herein and the indicator system is tuned such that when the color of the indicator system changes from bright pink to colorless, the biospecimen has been thawed, improperly stored, or improperly handled in a manner that may compromise the integrity of the biospecimen. As used herein, “biospecimen adjacent to,” “biospecimen associated with,” and “biospecimen in the vicinity of” the indicator system described herein, are used interchangeably and refer to the intimate proximity and simultaneous handling of the biospecimen and the indicator system such that the biospecimen and the indicator system constantly and continuously experience the same storage conditions, same temperature changes, and same environmental conditions. When the biospecimen is adjacent to, associated with, or in the vicinity of the indicator system, they may be in separate containers or vessels that are reversibly or irreversibly bound together. In some embodiments, the biospecimen may be associated with the indicator with tape, glue, a rubber band, parafilm, saran wrap, cling film, aluminum foil or tin foil, wrapped in paper, etc. The biospecimen and the indicator system may be in separate containers or vessels that are stored in the same box, container, freezer, or other appropriate storage system.

In some embodiments, the biospecimen is a biopsy sample. The biopsy sample may be immediately associated with the indicator system following excision from the subject such that the integrity of the biopsy sample can be continually monitored from excision up to fixation. Immediate association of the biopsy sample with the indicator system described herein ensures that the biopsy sample is not improperly handled after excision and before fixation to prevent inaccurate results of subsequent testing due to improper handling and storage of the biopsy sample. The biopsy sample may be any sample taken of a subject for suitable purposes known in the art. In some embodiments, the biopsy sample is a tissues sample for cancer diagnosis.

In some embodiments, the biospecimen is part of a biobank or an archive where long-term storage and handling of said biospecimen is to be monitored. In a biobank or archive, the indicator system described herein may be adjacent to or associate with a single biospecimen or group of biospecimens that are consistently handled simultaneously. Use of the indicator system described herein to monitor biobank or archive biospecimen samples ensures the integrity of the biospecimen over longer periods of time and across multiple laboratories or standard operating procedures (SOPs) responsible for maintaining the biobank or archive.

The indicator system comprises chemical components, that when mixed, provide a solution having an initial bright pink color that fades as a consequence of the reduction of permanganate to Mn²⁺. The chemical components of the indicator system may be selected such that when the liquid is colorless or below a threshold absorbance value, the indicator and any biospecimen associated therewith, may have been thawed, improperly stored, or improperly handled. The indicators are designed to function at a number of different temperature or storage regimes that are relevant to critical storage or handling parameters for a variety of biospecimens.

The indicator system described herein utilizes permanganate reaction chemistry with reaction kinetics controlled to be in parallel with the lifespan of a particular biospecimen of interest under thawed, improperly storage, or improperly handled conditions. Permanganate (MnO₄⁻), which gives the indicator an initial bright pink color, is reacted with a organic reducing agent, such as oxalate (C₂O₄²⁻) or its conjugate acid (H₂C₂O₄), under acidic conditions to yield colorless manganese (Mn²⁺), water, and carbon dioxide (Scheme 1). When the reaction composition is liquid, the reaction is autocatalytic and an initial bright pink color fades over time and becomes colorless. When the reaction is cooled, the reaction rate slows and when frozen solid, the reaction is essentially stopped.

2MnO₄⁻+6H₃O⁺+5H₂C₂O₄→2Mn²⁺+14H₂O+10CO₂ Scheme 1. Reduction of permanganate to Mn²⁺.

Oxalate is an exemplary organic reducing agent and other organic reducing agents may by utilized. Permanganate is able to oxidize carbon atoms if they contain sufficiently weak bonds, including (1) Carbon atoms with π bonds, such as alkenes and alkynes; (2) carbon atoms with weak C—H bonds, such as C—H bonds in the alpha-positions of substituted aromatic rings and C—H bonds in carbon atoms containing C—O bonds, including alcohols and aldehydes; and (3) carbons with exceptionally weak C—C bonds, such as C—C bonds in a glycol and C—C bonds next to an aromatic ring and an oxygen.

The composition and concentration of the chemical components allows for control of the freezing point of the indicator system and manipulation of the reaction rate such that the reaction rate and freezing point are in parallel with the lifespan of a thawed, improperly stored, or improperly handed biospecimen. When the reaction compositions changes from bright pink to colorless, the indicator indicates that the biospecimen may have compromised integrity and may no long be considered suitable for its intended use.

The chemical components of the indicator system are selected such that a mixture thereof forms a eutectic composition including permanganate, organic reducing agent, an acid, and a solvent, such as water. In some embodiments, the eutectic composition additionally includes an inorganic salt. The addition of an inorganic salt to the eutectic composition should be done at a concentration that maintains the eutectic properties of the composition and does not significantly alter the initial bright pink color of the composition.

As used herein, “eutectic composition” refers to a homogeneous composition that freezes and thaws at essentially a single temperature and does not partially freeze, partially thaw, or precipitate out of the composition. As used herein, “eutectic concentration” is the concentration of a compound at which the compound freezes and thaws at essentially a single temperature without partially freezing or partially thawing or the concentration of a compound in solution at which the solution freezes and thaws at essentially a single temperature without partially freezing or partially thawing.

As used herein, “essentially a single temperature” means that all of the chemical components of the eutectic composition freeze or thaw within 2.0° C. Accordingly, small deviations in the concentration of the components from a perfect eutectic concentration are contemplated. In some embodiments, all of the components of the eutectic composition freeze or thaw within 1.0° C., 0.5, or 0.2° C. of each other. When the difference in freezing or thawing temperatures of the components is too large, kinetic control of the permanganate/oxalic acid reaction system may be lost.

The permanganate (MnO₄⁻) in the eutectic composition may be provided as any suitable permanganate salt known in the art. The permanganate is provided in the eutectic composition at a concentration suitable to produce an initial bright pink color detectable to the naked eye. The permanganate may be present at a concentration between about 0.1 mM and about 10 mM (e.g., 0.1 mM, 0.25 mM, 0.5 mM, 0.75 mM, 1 mM, 1.5 mM, 2 mM, 2.5 mM, 3 mM, 4 mM, 5 mM, 6 mM, 7 mM, 8 mM, 9 mM, or 10 mM). Suitable permanganate salts include, but are not limited to, ammonium permanganate (NH₄MnO₄), potassium permanganate (KMnO₄), sodium permanganate (NaMnO₄), magnesium permanganate (Mg(MnO₄)₂), and any suitable hydrate thereof. In some embodiments, the permanganate is potassium permanganate at a concentration between about 0.1 mM and about 2 mM. In some embodiments, the permanganate is sodium permanganate at a concentration between about 0.1 mM and about 2 mM.

The presence of permanganate in the eutectic compositions gives an initial bright pink color. In general, the bright pink color is visible to the naked eye, and the naked eye can detect and observe the transition from bright pink to colorless during the reduction of permanganate. As used herein, “bright pink” or “pink” are used interchangeably and refer to the color associated with an absorbance at 525 nm. When measured using a spectrophotometer, the initial eutectic composition generally has an initial absorbance between about 1.0 and 1.5, but eutectic compositions having an initial absorbance outside of this range may also be utilized. Upon reduction of the permanganate in the eutectic composition, the color of the composition changes from pink to colorless as observed by the naked eye. When measured using a spectrophotometer, the colorless composition may have an absorbance at 525 nm of less than 0.1 (e.g., 0.1, 0.05, or 0). In some embodiments, thawing, improper storage, or improper handling of a biospecimen is indicated by a change in color from pink to colorless as observed by the naked eye and proper storage is indicated by a sustained pink color as observed by the naked eye. In some embodiments, thawing, improper storage, or improper handling of a biospecimen is indicated by at least a 50% reduction in absorbance at 525 nm when measured using a spectrophotometer and proper storage is indicated by a less than 50% reduction in absorbance at 525 nm when measured using a spectrophotometer. In some embodiments, thawing, improper storage, or improper handling of a biospecimen is indicated by at least a 80%, 90%, 95%, or 99% reduction in absorbance at 525 nm when measured using a spectrophotometer.

The organic reducing agent may be provided in any suitable for that allows for reduction of permanganate. The organic reducing agent may be present at a concentration between about 0.1 mM and about 100 mM (e.g., 0.1 mM, 0.25 mM, 0.5 mM, 0.75 mM, 1 mM, 1.5 mM, 2 mM, 2.5 mM, 3 mM, 4 mM, 5 mM, 6 mM, 7 mM, 8 mM, 9 mM, 10 mM, 15 mM, 20 mM, 25 mM, 30 mM, 35 mM, 40 mM, 45 mM, 50 mM, 55 mM, 60 mM, 65 mM, 70 mM, 75 mM, 80 mM, 85 mM, 90 mM, 95 mM, 100 mM). In some embodiments, the organic reducing agent is at a concentration between about 0.5 mM and about 20 mM.

Oxalate in the eutectic composition may be provided as oxalic acid or any suitable oxalate salt known in the art. The oxalate is provided in the eutectic composition at a concentration suitable to autocatalyze the reduction of permanganate to manganese. The oxalate concentration in the reaction is dependent on the permanganate concentration. The oxalate may be present at a concentration between about 0.1 mM and about 100 mM (e.g., 0.1 mM, 0.25 mM, 0.5 mM, 0.75 mM, 1 mM, 1.5 mM, 2 mM, 2.5 mM, 3 mM, 4 mM, 5 mM, 6 mM, 7 mM, 8 mM, 9 mM, 10 mM, 15 mM, 20 mM, 25 mM, 30 mM, 35 mM, 40 mM, 45 mM, 50 mM, 55 mM, 60 mM, 65 mM, 70 mM, 75 mM, 80 mM, 85 mM, 90 mM, 95 mM, 100 mM). Suitable oxalate compounds include, but are not limited to, oxalic acid (H₂C₂O₄), sodium oxalate (Na₂C₂O₄), potassium oxalate (K₂C₂O₄), and magnesium oxalate (MgC₂O₄). In some embodiments, the oxalate is sodium oxalate at a concentration between about 0.5 mM and about 20 mM. In some embodiments, the oxalate is potassium oxalate at a concentration between about 0.5 mM and about 20 mM.

The acid in the eutectic composition may be any suitable acid known in the art. The acid is provided in the eutectic composition at a concentration suitable to modulate the reaction rate as desired and ensure that the reaction remains autocatalytic when in liquid form. The acid may be present at a concentration between about 1 mM and about 5.0 M (e.g., 1 mM, 2 mM, 3 mM, 4 mM, 5 mM, 6 mM, 7 mM, 8 mM, 9 mM, 10 mM, 15 mM, 20 mM, 30 mM, 40 mM, 50 mM, 60 mM, 70 mM, 80 mM, 90 mM, 100 mM, 125 mM, 150 mM, 175 mM, 200 mM, 225 mM, 250 mM, 275 mM, 300 mM, 350 mM, 400 mM, 450 mM, 500 mM, 750 mM, 1.0 M, 1.5 M, 2.0 M, 2.5 M, 3.0 M, 3.5 M, 4.0 M, 4.5 M, and 5.0 M). In some embodiments the acid concentration is between 1 mM and 500 mM. Suitable acids may be selected from any known inorganic acid including, but are not limited to, sulfuric acid (H₂SO₄), hydrochloric acid (HCl), phosphoric acid (H₃PO₄), and perchloric acid (HClO₄).

In some embodiments, the eutectic composition additionally includes an inorganic salt. The inorganic salt is present in the eutectic composition at a concentration suitable to maintain the eutectic nature of the composition as a whole. The inorganic salt may be selected to tailor the predetermined freezing point to a desired storage or handling temperature or near the freezing point of the biospecimen. In some embodiments, the inorganic salt is present at a concentration between about 10% and about 50% by weight of the eutectic composition. In some embodiments, the inorganic salt may comprises an alkali or alkaline-earth metal cation and a suitable counter anion such as halide or sulfate. Suitable inorganic salts include, but are not limited to, lithium chloride (LiCl), magnesium chloride (MgCl₂), sodium chloride (NaCl), lithium sulfate (Li₂SO₄), ammonium chloride (NH₄Cl), potassium chloride (KCl), rubidium chloride (RbCl), cesium chloride (CsCl), beryllium chloride (BeCl₂), strontium chloride (SrCl₂), barium chloride (BaCl₂), sodium sulfate (Na₂SO₄), ammonium sulfate ((NH₄)₂SO₄), potassium sulfate (K₂SO₄), rubidium sulfate (Rb₂SO₄), cesium sulfate (Cs₂SO₄), beryllium sulfate (BeSO₄), magnesium sulfate (MgSO₄), strontium sulfate (Sr₅O₄), and barium sulfate (BaSO₄). Table 1 (adapted from Yatsenko et al., “Ice melting and crystallization in binary water-salt systems,” Inorganic Materials, 2002, 38(9):907-913) provides examples of eutectic concentrations of various inorganic salts suitable for use in the indicator systems described herein. Additional information can be found in Monnin et al. (“Thermodynamics of the LiCl+H₂O system,” J. Chem. Eng. Data, 2002, 47, 1331-1336) and Moran (“System lithium chloride-water,” J. Phys. Chem., 1956, 60(12):1666-1667).

TABLE 1
Properties of HCl and alkali and alkaline-earth chlorides
and sulfates and eutectics in water-salt systems

| | | | ΔₛₒₗH, | | Cₑ | | | |
|---|---|---|---|---|---|---|---|---|
| Salt | M, g | R_{c}, nm | kJ/mol | tₑ, ° C. | wt % | mol % | kₑ | n |
| HCl | 36.461 | 10⁻⁴ | −73.77 | −86 | 24.8 | 14.00 | 6.143 | 3 |
| LiCl | 42.394 | 0.068 | −36.26 | −67 | 24 | 11.82 | 5.668 | 3 |
| NaCl | 58.443 | 0.098 | 5.0 | −21.2 | 23.3 | 8.55 | 2.480 | 1 |
| NH₄Cl | 53.492 | 0.143 | 15.98 | −15 | 19.6 | 7.58 | 1.979 | 0 |
| KCl | 74.551 | 0.133 | 18.43 | −10.6 | 19.7 | 5.59 | 1.896 | 0 |
| RbCl | 120.92 | 0.148 | — | — | — | — | — | 0 |
| CsCl | 168.35 | 0.166 | — | — | — | — | — | 0 |
| BeCl₂ | 79.918 | 0.034 | — | — | — | — | — | — |
| MgCl₂ | 95.211 | 0.074 | −36.30 | −33.5 | 21.01 | 4.273 | 7.840 | 6 |
| CaCl₂ | 110.98 | 0.104 | −76.81 | −49.5 | 30.5 | 6.645 | 7.449 | 4 |
| SrCl₂ | 158.53 | 0.120 | −48.30 | −19 | 26.8 | 3.990 | 4.762 | 4 |
| BaCl₂ | 208.23 | 0.138 | −10.2 | −7.7 | 22.1 | 2.394 | 3.216 | 2 |
| Li₂SO₄ | 109.95 | 0.068 | −26.10 | −23 | 27.9 | 5.96 | 3.859 | 2 |
| Na₂SO₄ | 142.04 | 0.098 | −1.07 | −1.2 | 4.03 | 0.53 | 2.264 | 2 |
| (NH₄)₂SO₄ | 132.14 | 0.143 | 10.0 | −18.5 | 39.76 | 8.249 | 2.243 | 0 |
| K₂SO₄ | 174.26 | 0.133 | 26.88 | −1.55 | 6.49 | 0.712 | 2.177 | 1 |
| Rb₂SO₄ | 267.00 | 0.148 | 27.8 | — | — | — | — | — |
| CS₂SO₄ | 361.85 | 0.166 | 20.5 | — | — | — | — | — |
| BeSO₄ | 105.08 | 0.034 | — | — | — | — | — | — |
| MgSO₄ | 120.37 | 0.074 | −84.96 | −4.8 | 18.63 | 3.31 | 1.450 | 4 |
| CaSO₄ | 136.14 | 0.104 | −18 | — | — | — | — | 2 |
| SrSO₄ | 183.68 | 0.120 | 2 | — | — | — | — | — |
| BaSO₄ | 233.39 | 0.138 | — | — | — | — | — | — |

Note:
M is the molecular weight, R is the cation radius, ΔₛₒₗH is the heat of solution, tₑ is the eutectic temperature, Cₑ is the salt concentration in the eutectic, kₑ is the eutectic coefficient and n is the number of water molecules per formula unit.

The indicators described herein are suitable for applications in which the biospecimen has a desired storage and handling temperature below a threshold of 0° C. A “desired storage and handling temperature” is a temperature below which the biospecimen maintains its integrity. Below the desired storage and handling temperature, the reaction system described above will freeze and effectively halt indefinitely unless rewarmed.

In some embodiments, the predetermined freezing point is selected to be within the operating temperature of a freezer suitable for maintaining the biospecimen at a proper storage temperature or a temperature that maintains the biospecimen in a frozen state. Proper long-term preservation (e.g., biobanking) of many biospecimens, however, requires that they be stored at −80° C. or below (e.g., at the temperature of the vapor phase of liquid nitrogen, which is approximately −160° C.). Blood plasma and serum, for example, contain so much protein that these liquid specimens do not actually freeze until temperatures reach −30° C. or lower. As such, storage of blood plasma and serum at the common research laboratory freezer temperature of −20° C. is not acceptable because biochemical reactions within the samples can continue at this temperature, leading to sample expiration. Accordingly, a color-changing biospecimen integrity indicator that freezes at 0° C. would not be useful for comprehensively tracking the storage and handling conditions of an archived plasma or serum sample. An ideal tracker would be one that freezes near the freezing point of the specimen itself. If not available, a conservative tracker would be one that halted only at (or just above) the proper archival storage temperature.

In some embodiments, the predetermined freezing point is selected to indicate failure of a freezer suitable for maintaining the biospecimen at a proper storage and handling temperature or a temperature that maintains the biospecimen in a frozen state.

The selection of the components allows for the tailoring of the predetermined freezing point to a desired storage and handling temperature. The freezing point of eutectic composition is specific for the combination of components, such as the inorganic salt, and concentration of each of the components in the indicator system. The components of the indicator system may be selected based on known eutectic temperatures of inorganic salts so that the freezing point is to close to or specific to the biospecimen of interest or desired storage temperature. Exemplary embodiments, include 21.9% (w/w) magnesium chloride, which freezes eutectically at −33.5° C. and 25% (w/w) lithium chloride, which freezes eutectically at −76° C. Other magnesium chloride or lithium chloride concentrations resulted in a solution that either partially freezes or the salt partially precipitates out before the entire solution turns solid. Use of inorganic salts, Li₂SO₄ and NaCl, allow for monitoring biospecimen storage at −20° C. because Li₂SO₄ and NaCl have eutectic temperatures of −23° C. and −21° C., respectively.

In some embodiments, the freezing point of the eutectic composition is the same as or near the freezing point of the biospecimen of interest. As used herein, “freezing point near the freezing point of the biospecimen,” refers to a freezing point that is within 5° C. of the freezing point of the biospecimen. In some embodiments, the freezing point of the eutectic composition is within 2° C. of the freezing point of the biospecimen. In some embodiments, the freezing point of the eutectic composition is within 1° C. of the freezing point of the biospecimen.

In some embodiments, the predetermined freezing point may be less than −5° C., −10° C., −15° C., −20° C., −25° C., −30° C., −35° C., −40° C., −45° C., −50° C., −55° C., −60° C., −65° C., −70° C., −75° C., −80° C., −85° C., or −90° C.

The predetermined freezing point may be selected to be within different temperature regimes. In some embodiments, the predetermined freezing point may be between 0° C. to −15° C., 0° C. to −18° C., 0° C. to −20° C., 0° C. to −25° C., 0° C. to −30° C., 0° C. to −35° C., 0° C. to −40° C., 0° C. to −45° C., 0° C. to −50° C., 0° C. to −55° C., 0° C. to −60° C., 0° C. to −65° C., 0° C. to −70° C., 0° C. to −75° C., 0° C. to −80° C., 0° C. to −85° C., −15° C. to −30° C., −15° C. to −35° C., −15° C. to −40° C., −15° C. to −45° C., −18° C. to −30° C., −18° C. to −35° C., −18° C. to −40° C., −18° C. to −45° C., −20° C. to −30° C., −20° C. to −35° C., −20° C. to −40° C., −20° C. to −45° C., −25° C. to −30° C., −25° C. to −35° C., −25° C. to −40° C., −25° C. to −45° C., −35° C. to −80° C., −40° C. to −80° C., −45° C. to −80° C., −50° C. to −80° C., −35° C. to −85° C., −40° C. to −85° C., −45° C. to −85° C., or −50° C. to −85° C.

The reaction rate of the liquid eutectic composition can be modulated or tuned based on the compounds included in the compositions as well as the concentrations therein. In some embodiments, the concentration of the acid is increased to increase the reaction rate. In some embodiments, the concentration of the acid is reduced to reduce the reaction rate. In some embodiments, the initial concentration of Mn²⁺ in the system is increased to increase the reaction rate or reduced to reduce the reaction rate.

A notable feature of the system is that the color transition is non-linear with time; specifically, it stays at the original bright pink color until shortly before it expires. This is due to the autocatalytic nature of the reaction chemistry involved. As the reaction approaches its end point, it undergoes a rapid transition from bright pink to clear.

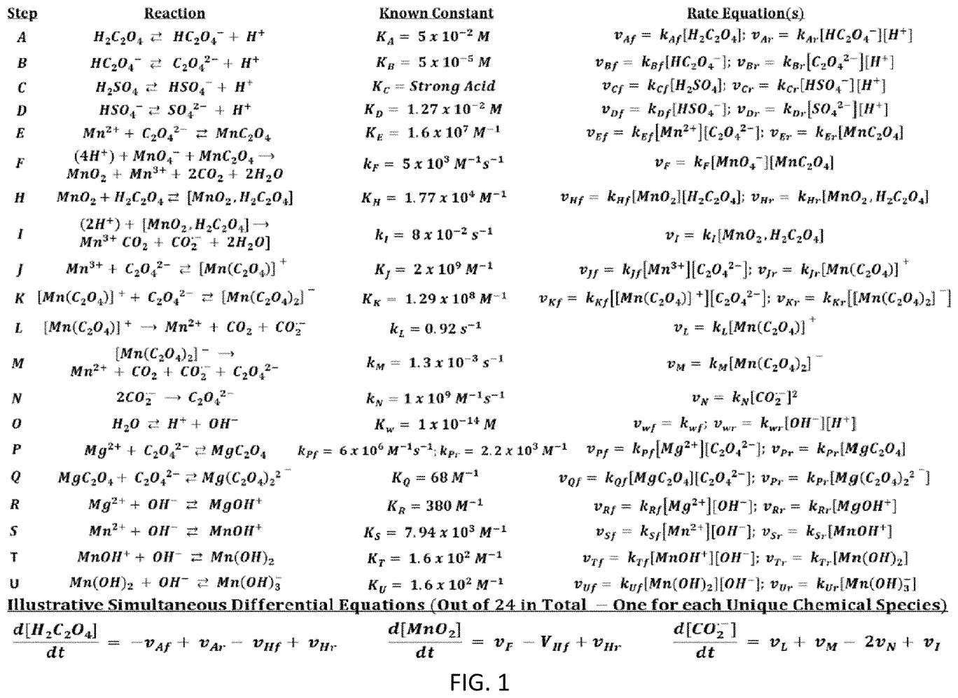

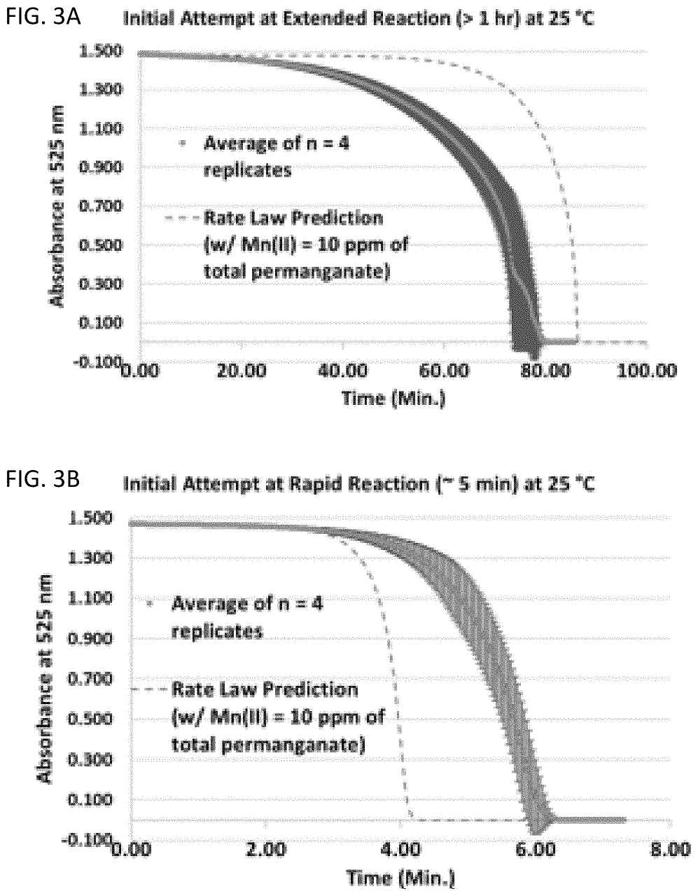

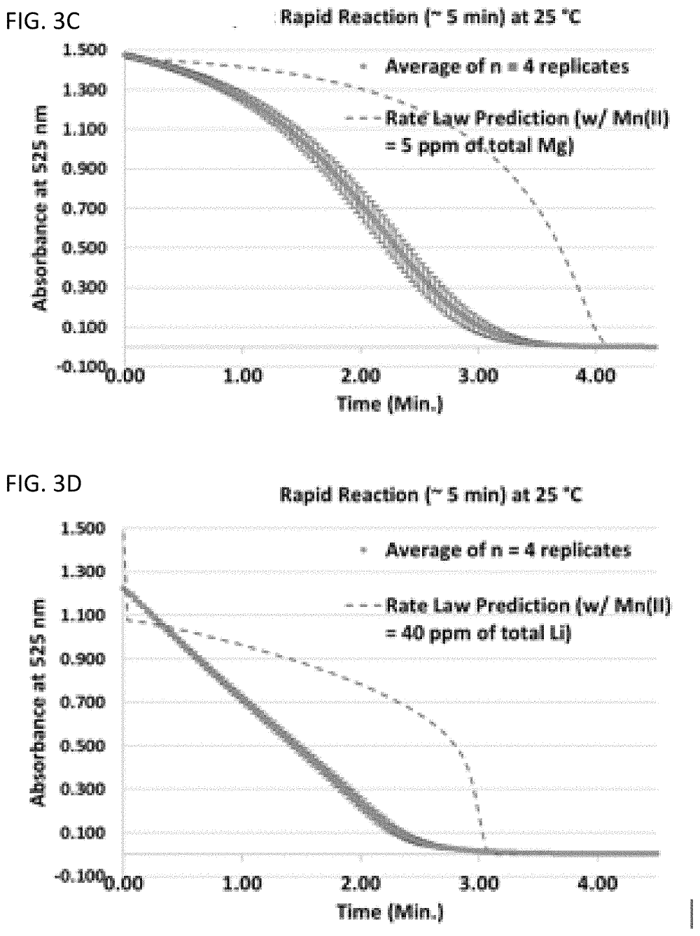

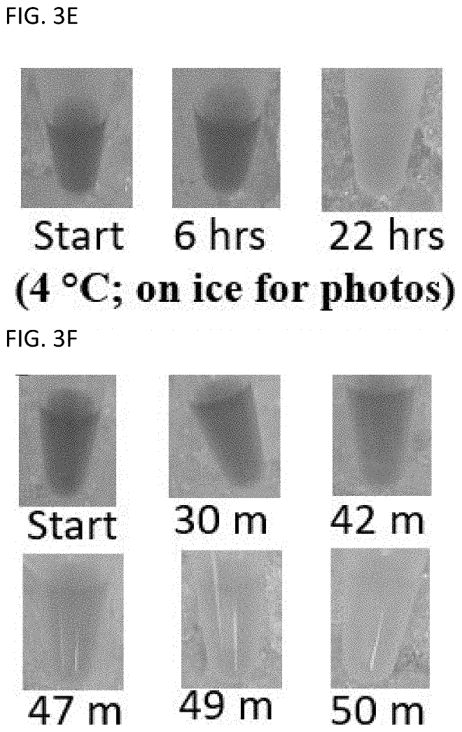

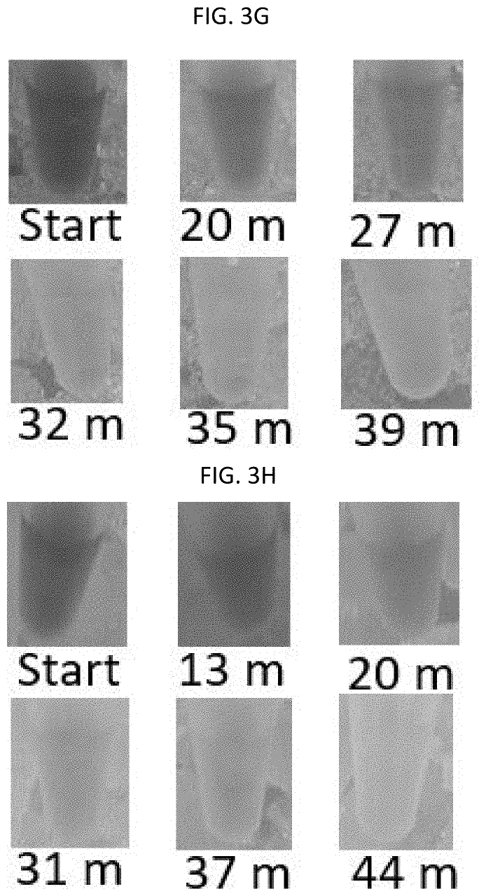

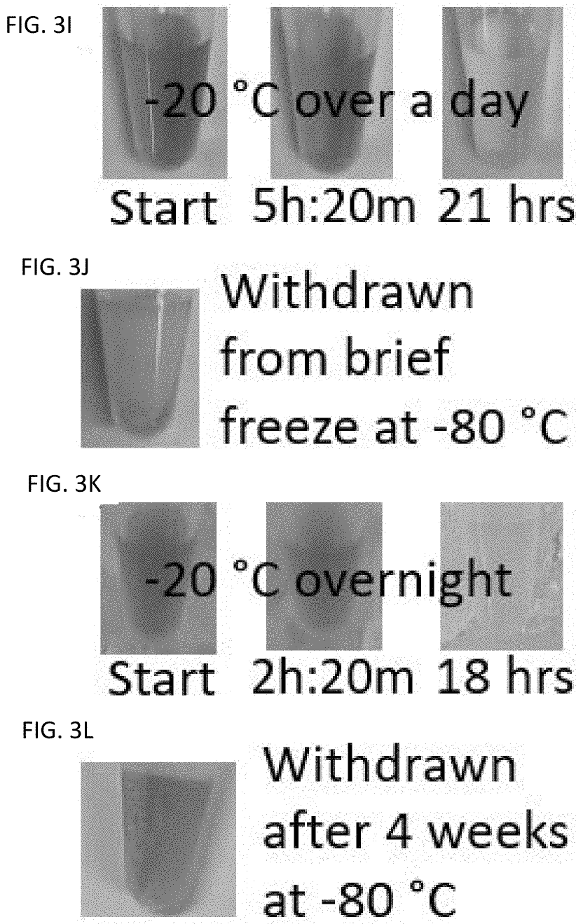

The reaction mechanism is complex and takes place in numerous different steps that interplay with one another (FIG. 1), but the rate law and/or equilibrium constant at room temperature (25° C.) for each step is known. The chemical reactions and their rate equations outlined in FIG. 1 serve as the basis for 24 simultaneous differential equations that are solved numerically to simulate the reaction kinetics of the permanganate-oxalate reaction governing the liquid indicator described herein. Illustrative differential equations that serve as input to the computer simulation are shown at bottom of FIG. 1. In total there are 24 simultaneous differential equations that, when numerically integrated, provide the concentration of each chemical at each point in time given reactant starting concentrations. Reactions, constants and rate equations for steps A-N are from Pimienta et al ^{[1]}. K_{w} ^{[7]}, k_{pf} and kₚᵣ ^{[2]}, and K_{Q}-K_{U} ^{[3, 4]} are from other sources. When only an equilibrium constant is available, the correct ratio of non-rate limiting, arbitrarily assigned forward and reverse rate constants may be employed in the simulation. Formation of Mg(OH)₂ is assumed to be negligible under all relevant reaction conditions and is not included in the presently utilized model. Reaction predication lines shown in FIG. 3A-3D are examples of the tunable reaction conditions possible with the described indicator system. Although FIG. 1 provides the kinetics of the permanganate-oxalate reaction, such methodology may be exploited for different permanganate-organic reducing agent reactions.

Running simulations with different reaction starting conditions makes it possible to select the components of the indicator system with tailored lifetimes over different timescales. As used herein, the “lifetime” of the indicator system is the length of time necessary for the indicator system to go from the initially mixed eutectic composition to a state indicating thawing, improper storage, or improper handing at a particular temperature above the predetermined freezing point. In some embodiments, the indicator system has a lifetime less than 7 days, 6, days, 5, days, 4, days, 3, days, 2, days, 24 hrs, 18 hrs, 12 hrs, 6 hrs, 5 hrs, 4 hrs, 3 hrs, 2 hrs, 60 mins, 45 mins, 30 mins, 25 mins, 20 mins, 15 mins, 10 mins, 9, mins, 8 mins, 7 mins, 6 mins, 5 mins, 4 mins, 3 mins, 2 mins, or 1 min at a particular temperature above the predetermined freezing point.

In some embodiments, the chemical components are selected for the indicator system to have a lifetime of less than 120, 90, 60, 45, 30, 25, 20, 15, 10, 9, 8, 7, 6, 5, 4, 3, 2, or 1 min at 25° C. Indicator systems having lifetimes at 25° C. less than 120 mins may be appropriate for applications such as initial biospecimen collection and handling prior to storage. Indicator systems having lifetimes at 25° C. less than 1 min may be appropriate for applications such as long-term storage where storage above −30° C. or thawing of the biospecimen is improper.

In some embodiments, the chemical components are selected for the indicator system to have a lifetime of less than 24, 18, 12, 10, 9, 8, 7, 6, 5, 4, 3, 2, or 1 hr at 4° C. Indicator systems having lifetimes at 4° C. less than 24 hrs may be appropriate for applications such as initial biospecimen collection and handling prior to storage.

In some embodiments, the chemical components are selected for the indicator system to have a lifetime of less than 60, 45, 30, 25, 20, 15, 10, 9, 8, 7, 6, 5, 4, 3, 2, or 1 min at 0° C. Indicator systems having lifetimes at 0° C. less than 60 mins may be appropriate for applications such as long-term storage where brief storage above −30° C. or thawing of the biospecimen may be permissible.

In some embodiments, the chemical components are selected for the indicator system to have a lifetime of less than 7 days, 6, days, 5, days, 4, days, 3, days, 2, days, 24 hrs, 18 hrs, 12 hrs, 6 hrs, 5 hrs, 4 hrs, 3 hrs, or 2 hrs at −20° C. Indicator systems having lifetimes at −20° C. less than 4 hrs may be appropriate for applications such as long-term storage where storage above −30° C. or thawing of the biospecimen is improper. Indicator systems having lifetimes at −20° C. between 24 and 4 hrs may be appropriate for applications such as long-term storage where brief storage above −30° C. or thawing of the biospecimen may be permissible. Indicator systems having lifetimes at −20° C. between 7 and 1 days may be appropriate for applications such as collection or temporary storage of the biospecimen at sites lacking cold storage less than −20° C.

In some embodiments, the eutectic compositions of the indicator system has a freezing point of 0° C. and includes about 1 mM KMnO₄, about 3 mM organic reducing agent, and about 10 mM sulfuric acid and, when in liquid form, the reduction reaction is completed in between about 80 and about 90 minutes.

In some embodiments, the eutectic compositions of the indicator system has a freezing point of 0° C. and includes about 1 mM KMnO₄, about 3 mM sodium oxalate, and about 10 mM sulfuric acid and, when in liquid form, the reduction reaction is completed in between about 80 and about 90 minutes.

In some embodiments, the eutectic compositions of the indicator system has a freezing point of 0° C. and includes about 1 mM KMnO₄, about 3 mM organic reducing agent, and about 240 mM sulfuric acid and, when in liquid form, the reduction reaction is completed in between about 4 and about 6 minutes.

In some embodiments, the eutectic compositions of the indicator system has a freezing point of 0° C. and includes about 1 mM KMnO₄, about 3 mM sodium oxalate, and about 240 mM sulfuric acid and, when in liquid form, the reduction reaction is completed in between about 4 and about 6 minutes.

In some embodiments, the eutectic composition of the indicator system has a freezing point of −76° C., includes about 1 mM KMnO₄, about 3 mM organic reducing agent, about 10 mM sulfuric acid, and about 25% by weight LiCl, and the reduction reaction is completed in between about 20 minutes and about 35 minutes at 0° C. or after about 12 hours at −20° C.

In some embodiments, the eutectic composition of the indicator system has a freezing point of −76° C., includes about 1 mM KMnO₄, about 3 mM sodium oxalate, about 10 mM sulfuric acid, and about 25% by weight LiCl, and the reduction reaction is completed in between about 20 minutes and about 35 minutes at 0° C. or after about 12 hours at −20° C.

In some embodiments, the eutectic composition of the indicator system has a freezing point of −33.5° C. includes about 1 mM KMnO₄, about 3 mM organic reducing agent, about 10 mM sulfuric acid, and about 22% by weight MgCl₂, the reduction reaction is completed in between about 28 minutes and about 33 minutes at 0° C. or after about 15 hours at −20° C.

In some embodiments, the eutectic composition of the indicator system has a freezing point of −33.5° C. includes about 1 mM KMnO₄, about 3 mM sodium oxalate, about 10 mM sulfuric acid, and about 22% by weight MgCl₂, the reduction reaction is completed in between about 28 minutes and about 33 minutes at 0° C. or after about 15 hours at −20° C.

Biospecimen collection and storage systems are also provided. The biospecimen collection and storage system may comprise any of the indicator systems described herein and a biospecimen storage vessel. As used herein, a “biospecimen storage vessel” is a vessel configured to hold a biospecimen. Suitably the biospecimen storage vessel is a well, vial, cup, bag, or other container suitable for storing a specimen for temporary or extended storage. As used herein, “temporary storage” refers to storage durations of hours, days, or up to about a week and “extended storage” refers to storage durations of more than about a week, including storage durations of more than a month, more than a year, or unlimited duration storage.

The indicator system should be initially configured to prevent reduction of the permanganate into Mn²⁺ but also configured to allow a user to prepare a mixture of the permanganate, the organic reducing agent, the acid, the aqueous solvent, and, if present, the inorganic salt is an eutectic composition having a predetermined freezing point. This allows for the user to initiate the reduction reaction at the point where it would be desirable to begin monitoring the biospecimen.

In some embodiments, the indicator system will be associated outside of the biospecimen storage vessel and never physically touch the biospecimen that is to be stored in the biospecimen storage vessel. This allows for observation of the indicator system without disturbing a biospecimen within the biospecimen storage vessel.

In some embodiments, the indicator system may be configured as a multi-chambered storage vessel. The multi-chambered storage vessel may comprise a removable barrier defining at least a first chamber and a second chamber. As used herein, a “removable barrier” is one that is configured to be removed or lose structural integrity, thereby eliminating the distinction between the chambers. The chemical components may be distributed between the two or more chambers in any suitable manner that prevents reduction of permanganate to Mn²⁺. In some embodiments, the permanganate is housed in the first chamber and the organic reducing agent is housed in the second chamber. In a particular embodiments, one chamber houses a permanganate salt and the other chamber houses a solution comprising organic reducing agent, the acid, and the aqueous solvent. If the inorganic salt is present, it may be housed with the permanganate or with the solution. In some embodiments, the inorganic salt is housed with the solution. The indicator system may be initiated by bending, flexing, crushing, snapping, creasing, or breaking the removable barrier, thereby allowing chemical components in the different chambers to mix.

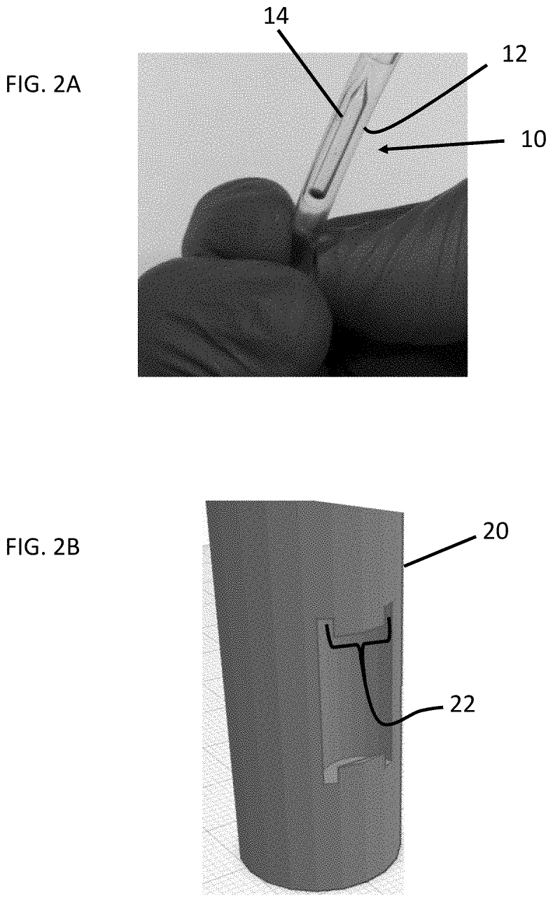

FIG. 2A shows an exemplary multi-chambered storage vessel 10. The multi-chambered storage vessel may comprise an outer chamber 12 and an inner chamber 14 defined by a removable barrier. In an exemplary embodiments, the permanganate, such as a permanganate salt, may be housed within the inner chamber 12, and the organic reducing agent may be housed in to the outer chamber 12. The outer chamber 12 may be surrounded by a flexible material that can be manipulated without losing structural integrity. In inner chamber 14, in contrast, may be surrounded by a rigid or brittle material that cannot withstand such manipulation. Such an indicator will allow mixing of the chemical components with the indicator is bent, flexed, creased, or snapped. Although the exemplary embodiment shown in FIG. 2A shows the inner chamber 14 within the outer chamber 12, the chambers may be configured in other arrangements, such as having the chambers side-by-side.

In some embodiments, the biospecimen storage vessel may be configured to be associated with the indicator system. An exemplary biospecimen collection vessel 20 is shown in FIG. 2B having a recess 22 that allows for the association of the biospecimen collection vessel with an indicator system, such as the indicator system illustrated in FIG. 2A. The recess 22 may be configured to reversibly or irreversibly associate with the indicator system on the outer surface of the biospecimen collection vessel 20. This may allow for observation of the indicator system without disturbing a biospecimen.

In some embodiments, the biospecimen storage vessel and the indicator system is incorporated into a portion of a biospecimen storage vessel. For example, the indicator system may be incorporated into a cap, a wall, a parallel vertical or horizontal chamber, in a single well of a multiwall plate, or in multiple wells of a multiwall plate, each of which are also are suitable for holding and storing the biospecimen.

In some embodiments, the indicator system may be incorporated into packaging that is intended to surround the biospecimen storage vessel. For example, the indicator system may be incorporated into a box or bag suitable for surrounding the biospecimen storage vessel.

In some aspects, provided herein a kit including the indicator system as described herein and a storage vessel that incorporates the indicator system and can be used to store the biospecimen. In some embodiments, the kit comprises separate solutions for each of the indicator system components.

In some aspects, provided herein is a method of monitoring the integrity of a biospecimen including the steps of obtaining an indicator system as described herein with a predetermined freezing point near of the freezing point of the biospecimen or a storage or handling temperature for the biospecimen, storing the biospecimen adjacent to the indicator system and handling the biospecimen and indicator system simultaneously, and observing the color of the indicator system. A change in color from prink to colorless indicates a loss of integrity of the biospecimen due to thawing, improper handling, or improper storage. Accordingly, a user may store a biospecimen in a biospecimen storage vessel and the indicator system may be associate with the biospecimen or the biospecimen storage vessel. When desirable to begin monitoring the storage or handling of the biospecimen, the permanganate, the organic reducing agent, the acid, the aqueous solvent, and optionally the inorganic salt, may be mixed, thereby forming the eutectic composition. As a result of mixing, the indicator system will display a bright pink color and the permanganate reduction reaction will be initiate. When using an indicator system with a multi-chambered storage vessel, mixing the chemical components may be accomplished by removing the removable barrier separating the permanganate from the organic reducing agent.

In some embodiments, the color change may be observed with the naked eye. In some embodiments, the color change is observed by measuring absorbance of the indicator system at 525 nm. When the absorbance of the indicator system at 525 nn is less than 0.1, less than 0.05, or 0, the integrity of the biospecimen is lost due to thawing, improper handling, or improper storage. In some embodiments, the indicator system is in a well of a multiwall plate or in a cuvette to facilitate easy measuring of the absorbance.

Unless defined otherwise, all technical and scientific terms used herein have the same meaning as commonly understood by one of ordinary skill in the art to which the invention pertains. All definitions, as defined and used herein, should be understood to control over dictionary definitions, definitions in documents incorporated by reference, and/or ordinary meanings of the defined terms.

All references, patents and patent applications disclosed herein are incorporated by reference with respect to the subject matter for which each is cited, which in some cases may encompass the entirety of the document.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of” “Consisting essentially of” when used in the claims, shall have its ordinary meaning as used in the field of patent law.

As used herein, the terms “approximately” or “about” in reference to a number are generally taken to include numbers that fall within a range of 5% in either direction (greater than or less than) the number unless otherwise stated or otherwise evident from the context (except where such number would exceed 100% of a possible value). Where ranges are stated, the endpoints are included within the range unless otherwise stated or otherwise evident from the context.

The present invention has been described in terms of one or more preferred embodiments, and it should be appreciated that many equivalents, alternatives, variations, and modifications, aside from those expressly stated, are possible and within the scope of the invention.

### EXAMPLES

We have developed color change-based indicator liquids designed for multiple unique biospecimen handling/storage requirements. The internal chemical reaction “clock” that runs these indicators slows as samples are cooled and halts when they are frozen—but restarts when samples are thawed, without limit to the number of freeze-thaw cycles. Importantly, subsets of these indicators do not freeze until −33.5° C. or −76° C., facilitating the unprecedented ability to track exposures to nominally very cold, but nevertheless improper storage temperatures.

Table 2 provides exemplary embodiments that may be prepared from indicator systems described herein.

TABLE 2
Targeted indicators, their desired performance metrics and intended applications. Bold font indicates
the primary targeted lifetime of the indicator at the temperature of the column header

| | Solution | | | | | | | |
|---|---|---|---|---|---|---|---|---|
| Indicator | Composition | | | | | On Ice | | −80° C./ |
| # | (Freezing Pt) | 25° C. | | 4° C. | | (0° C.) | −20° C. | −160° C. |
| #1 | H₂O (0° C.) | 1 | hr | ~10 | hrs | N/A | N/A | N/A |
| #2 | H₂O (0° C.) | 1.5 | hrs | ~15 | hrs | N/A | N/A | N/A |
| #3 | H₂O (0° C.) | 2 | hrs | ~20 | hrs | N/A | N/A | N/A |
| #4 | H₂O (0° C.) | ~1.8 | hrs | 18 | hrs | N/A | N/A | N/A |
| #5 | H₂O (0° C.) | ~2.5 | hrs | 24 | hrs | N/A | N/A | N/A |

| #6 | H₂O (0° C.) | ~6 | min | N/A | 1 | hr | N/A | | N/A |
|---|---|---|---|---|---|---|---|---|---|
| #7 | 21.9% (w/w) MgCl₂ | 1 | min | N/A | ~12 | min | ~4 | hrs | Stays |
| | (−33.5° C.) | | | | | | | | Pink |
| #8 | 21.9% (w/w) MgCl₂ | ~7 | min | N/A | 1 | hr | 20 | hrs | Stays |
| | (−33.5° C.) | | | | | | | | Pink |

| | | | | | | | | | |
|---|---|---|---|---|---|---|---|---|---|
| #9 | 21.9% (w/w) MgCl₂ | ~1 | hr | ~10 | hrs | N/A | 7 | days | Stays |
| | (−33.5° C.) | | | | | | | | Pink |

| | | | | | | | | | |
|---|---|---|---|---|---|---|---|---|---|
| #10 | 25% (w/w) LiCl | 1 | min | N/A | ~10 | min | ~3 | hrs | Stays |
| | (−76° C.) | | | | | | | | Pink |
| #11 | 25% (w/w) LiCl | ~6 | min | N/A | 1 | hr | ~18 | hrs | Stays |
| | (−76° C.) | | | | | | | | Pink |

| | | | | | | | | | |
|---|---|---|---|---|---|---|---|---|---|
| #12 | 25% (w/w) LiCl | ~45 | min | ~8 | hrs | N/A | 7 | days | Stays |
| | (−76° C.) | | | | | | | | Pink |

| | Closest | |
|---|---|---|
| Indicator | Preliminary | |
| # | Example | Example Application for Targeted Time/Temperature |
| #1 | EX. 1 | Initial Blood or Tissue Collection. Time frame allows |
| | | for processing to final storage condition. |
| #2 | EX. 1 | Initial Blood or Tissue Collection. Time frame allows |
| | | for processing to final storage condition. |
| #3 | EX. 1 | Initial Blood or Tissue Collection. Time frame allows |
| | | for processing to final storage condition. |
| #4 | EX. 1 | Initial Blood or Tissue Collection. Time frame allows |
| | | for processing to final storage condition. |
| #5 | EX. 1 | Initial Blood or Tissue Collection. Time frame allows |
| | | for processing to final storage condition. |
| #6 | EX. 2 | Initial Blood or Tissue Collection. Time frame allows |
| | | for processing to final storage condition. |
| #7 | EX. 3 | Long term storage of plasma/serum or tissue aliquots |
| | | with NO freeze-thaws or storage >−30° C. allowed |
| #8 | EX. 3 | Long term storage of plasma/serum or tissue aliquots |
| | | with 1-2 freeze-thaws or brief storage >−30° C. allowed |
| #9 | Must elim. | Collection and temporary storage of specimens at |
| | Mn²⁺ 1st | satellite sites that lack storage colder than −20° C. |
| #10 | EX. 4 | Long term storage of any biospecimens for which NO |
| | | freeze-thaws or storage >−80° C. is allowed |
| #11 | EX. 4 | Long term storage of any biospecimens for which 1-2 |
| | | freeze-thaws or brief storage >−80° C. allowed |
| #12 | Must elim. | Collection and temporary storage of specimens at |
| | Mn²⁺ 1st | satellite sites that lack storage colder than −20° C. |

All samples here contained 1 mM KMnO₄ and 3 mM disodium oxalate. Example 2 contained 240 mM H₂SO₄ and Examples 1, 3, and 4 contained 10 mM H₂SO₄. Examples 3 and 4 contained a eutectic composition of MgCl₂ (Example 3) or LiCl (Example 4).

EXAMPLE 1: Extended reaction at room temperature—A reaction system including 1 mM KMnO₄, 3 mM sodium oxalate, and 10 mM H₂SO₄ and maintained at room temperature (25° C.) has a simulated completion time of 90 minutes. When tested and monitored at an absorbance of 525 nm, the completion time is approximately 80 minutes. See FIG. 3A.

At 4° C., the reaction is slowed and a reaction system including 1 mM KMnO₄, 3 mM sodium oxalate, and 10 mM H₂SO₄ had a completion time of up to 22 hours. See FIG. 3E.

EXAMPLE 2: Rapid reaction system at room temperature—The concentration of acid in the reaction system plays an important role in driving the reaction rate. A reaction system including 1 mM KMnO₄, 3 mM sodium oxalate, and 240 mM H₂SO₄ and maintained at room temperature (25° C.) has a simulated completion time of about 4 minutes. When tested and monitored at an absorbance of 525 nm, the completion time is approximately 6 minutes. FIG. 3B. If the acid concentration is reduced below 10 mM under these conditions, the reaction stalls and forms brown MnO₂ as the end product.

At 0° C., the reaction is slowed and a reaction system including 1 mM KMnO₄, 3 mM sodium oxalate, and 240 mM H₂SO₄ had a completion time of up to 50 mins. See FIG. 3F.

EXAMPLE 3: MgCl as an antifreeze salt—The eutectic composition of the indicator system has a freezing point of −33.5° C. includes about 1 mM KMnO₄, about 3 mM sodium oxalate, about 10 mM sulfuric acid, and about 22% by weight MgCl₂. MgCl₂ at a eutectic concentration does not allow the reaction to proceed at −80° C. (FIG. 3J). At −20° C., the indicator composition is a liquid and the reaction is autocatalytic (FIG. 3I), The reduction reaction is completed in between bout 3 and 4 minutes at 25° C. (FIG. 3C), about 28 minutes and about 33 minutes at 0° C. (FIG. 3G) or after about 15 hours at −20° C. (FIG. 3I).

EXAMPLE 4: LiCl as an antifreeze salt—The eutectic composition of the indicator system has a freezing point of −76° C., includes about 1 mM KMnO₄, about 3 mM sodium oxalate, about 10 mM sulfuric acid, and about 25% by weight LiCl. LiCl at a eutectic concentration does not allow the reaction to proceed at −80° C. (FIG. 3L). At −20° C., the indicator composition is a liquid and the reaction is autocatalytic (FIG. 3K). The reduction reaction is completed in between about 2 and 3 minutes at 25° C. (FIG. 3D), about 28 minutes and about 33 minutes at 0° C. (FIG. 3H) or after about 15 hours at −20° C. (FIG. 3K).

Evaluation of the exemplary indicator systems demonstrates that decreasing temperature dramatically slows the reaction but otherwise leave it qualitatively the same.

Endogenous Mn²⁺ eradication-Mn²⁺ may be present as an autocatalytic contaminant in the reaction system that originate from as-purchased chemicals. For some targeted indicator solutions (Table 2), this drives the reaction system faster than desired. Endogenous, contaminating Mn²⁺ species may be removed by the use of an inorganic cation exchange resin to bind multivalent metal cations. For example, pre-treating KMnO₄ is expected to minimize the Mn²⁺ contaminating species in the starting reaction system. Alternatively, prewashing all labware with ultrapure 2% nitric acid, passing ozone through the stock solutions and/or treating them with peroxodisulfate to stoichiometrically oxidize all Mn²⁺ to MnO₄⁻ may also be employed. Depletion of this contaminating species is important as this would allow for the reaction to be carried on for a longer duration and also minimize formation of MnO₂ that can result in a brown product.

### REFERENCES

1. Pimienta V, Lavabre D, Levy G, Micheau J C: Kinetic Modeling of the KMnO4/H2C2O4/H2SO4 Reaction—Origin of the Bistability in a CSTR. J Phys Chem-Us 1995, 99(39):14365-14371.
2. Lin C T, Bear J L: The Kinetics of Formation of Magnesium Oxalate. J Inorg Nucl Chem 1969, 31(2):263-269.
3. Speight J G: Lange's Handbook of Chemistry (Table 1.75—Cumulative Formation Constants for Metal Complexes with Inorganic Ligands). New York: McGraw-Hill; 2005.
4. Speight J G: Lange's Handbook of Chemistry (Table 1.76—Cumulative Formation Constants for Metal Complexes with Organic Ligands). New York: McGraw-Hill; 2005.
5. Reisz, E., Leitzke, A., Jarocki, A., Irmscher, R., and von Sonntag, C. (2008) Permanganate formation in the reactions of ozone with Mn(II): a mechanistic study. J. Water Supply Res. Technol. 57, 451-464.
6. Wallin, J., and Klein-Paste, A. (2016) Chemical Melting of Ice: Effect of Solution Freezing Point on the Melting Rate. Transp. Res. Rec. J. Transp. Res. Board 2551, 111-117.
7. Skoog D A, West D M, Holler F J, Crouch S R: Fundamentals of Analytical Chemistry, 9th Ed. Belmont, Calif.: Brooks/Cole; 2014

We claim:

1. An indicator system comprising permanganate, an organic reducing agent, an acid, an aqueous solvent, and optionally an inorganic salt initially configured to prevent reduction of the permanganate to Mn²⁺,
wherein a mixture of the permanganate, the organic reducing agent, the acid, the aqueous solvent, and, if present, the inorganic salt is an eutectic composition having a predetermined freezing point, and
wherein when above the predetermined freezing point the mixture is a liquid and the organic reducing agent causes a reduction reaction of permanganate to Mn²⁺ and when below the predetermined freezing point the mixture is a solid and the reduction reaction is stopped.

2. The indicator system of claim 1, wherein the indicator system comprises between 15% and 30% by weight of the inorganic salt.

3. The indicator system of claim 1, wherein the predetermined freezing point is less than −15.0° C.

4. The indicator system of claim 3, wherein the predetermined freezing point is less than −30.0° C.

5. The indicator system of claim 1 further comprising a multi-chambered storage vessel comprising a removable barrier defining a first chamber having the permanganate therein and a second chamber having the organic reducing agent therein, wherein the removable barrier is configured to prevent the permanganate and the organic reducing agent from mixing.

6. The indicator system of claim 5, wherein the first chamber has a solid permanganate salt therein and the second chamber has a solution comprising the organic reducing agent, the acid, the aqueous solvent, and, if present, the inorganic salt therein.

7. The indicator system of claim 8, wherein the indicator system comprises between 15% and 30% by weight of the inorganic salt and wherein the predetermined freezing point is less than −15.0° C.

8. The indicator system of claim 1, wherein the eutectic composition has an initial absorbance at 525 nm greater than 1.00 and is pink in color upon mixing and wherein, when measured at 525 nm, absorbance of the liquid composition decreases over a predetermined period of time.

9. The indicator system of claim 8, wherein, when measured at 525 nm, absorbance of the solid composition remains unchanged.

10. The indicator system of claim 1, wherein the eutectic composition comprises between 0.5 and 5 mM permanganate, between 0.5 and 5 mM organic reducing agent and between 1 mM and 300 mM sulfuric acid.

11. The indicator system of claim 10, wherein the eutectic composition further comprises between about 15% and about 30% by weight of the inorganic salt.

12. The indicator system of claim 11, wherein the predetermined freezing point is −33.5° C. and the eutectic composition comprises between 20% and 23% by weight MgCl₂ or wherein the predetermined freezing point is −76° C. and the eutectic composition comprises between 23% and 27% LiCl.

13. A biospecimen collection or storage system comprising a biospecimen storage vessel and the indicator system according to claim 1.

14. The biospecimen collection or storage system of claim 13, wherein the indicator system comprises the inorganic salt and the predetermined freezing point is less than −15° C.

15. The biospecimen collection or storage system of claim 14, wherein the biospecimen storage vessel comprises a recess configured to receive the indicator system and allow observation of the indicator system without disturbing the biospecimen.

16. The biospecimen collection or storage system of claim 14, wherein the indicator system further comprising a multi-chambered storage vessel comprising a removable barrier defining a first chamber having the permanganate therein and a second chamber having the organic reducing agent therein, wherein the removable barrier is configured to prevent the permanganate and the organic reducing agent from mixing.

17. A method for monitoring storage or handling of a biospecimen comprising
storing a biospecimen in a biospecimen storage vessel;
associating the indicator system according to claim 1 with the biospecimen or the biospecimen storage vessel;
mixing the permanganate, the organic reducing agent, the acid, the aqueous solvent, and optionally the inorganic salt, thereby forming the eutectic composition;
observing the color of the eutectic composition or measuring absorbance at 525 nm;
wherein a color change from pink to colorless or absorbance less than 0.1 indicates thawing, improper storage, or improper handling of the biospecimen.

18. The method of claim 17, wherein the predetermined freezing temperature is within 5.0° C. of the freezing point of the biospecimen or a storage or handling temperature for the biospecimen.

19. The method of claim 17, wherein the predetermined freezing point is less than −15.0° C.

20. The method of claim 17, wherein the mixing step comprises removing a removable barrier defining a first chamber of a multi-chambered storage vessel having a solid permanganate salt therein and a second chamber of the multi-chambered storage vessel having the organic reducing agent, the acid, the aqueous solvent, and, if present, the inorganic salt therein.
